(19) United States
(12) Patent Application Publication
(10) Pub. No.: US 2009/0312011 A1
(43) Pub. Date: Dec. 17, 2009

(54) COMMUNICATIONS DEVICES COMPRISING NEAR FIELD RF COMMUNICATORS

(75) Inventors: Heikki Huomo, Meysey Hampton (GB); Ian J. Keen, Yately (GB); Marc A. Borrett, Winterbourne Steepleton (GB); Kevin Lamacraft, Teddington (GB)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Innovision Research & Technology PLC, Cirencester (GB)

(21) Appl. No.: 12/448,269

(22) PCT Filed: Dec. 7, 2007
(86) PCT No.: PCT/GB2007/004693

§ 371 Date: Jun. 12, 2009

(30) Foreign Application Priority Data
Dec. 15, 2006 (GB) 0625093.0
Jun. 18, 2007 (GB) 0711782.3

(51) Int. Cl. H04W 4/00; H04B 5/00; G06Q 10/00; G06Q 50/00

(52) U.S. Cl. 455/426.1; 455/41.1; 705/30; 705/5

(57) ABSTRACT

A communications device has a near field RF communicator (15) having a coupler (17) to couple with a coupler of a near field RF communicator or NFC communicator in near field range to enable communication of data between the communicators by modulation of a magnetic field, and a modulator (43) to modulate an RF signal in accordance with data to be communicated by the near field RF communicator. The device also has at least one secure element (31) separate from the near field RF communicator (15) to provide secure data storage for transaction data representing or relating to a transaction. A controller controls operation of the near field RF communicator, reads transaction data from the at least one secure element and causes the modulator to modulate an RF signal in accordance with transaction data read from the at least one secure element so as to communicate the read transaction data to a near field RF communicator or NFC communicator in near field range as proof of the transaction to enable an action related to the transaction to be carried out.

### CROSS-REFERENCE TO RELATED APPLICATIONS

The present application is a national phase entry under 35 U.S.C. § 371 of International Application No. PCT/GB2007/004693, filed Dec. 7, 2007 and published as WO 2008/071924 in English, which claims priority from UK Patent Application No. 0625093.0, filed Dec. 15, 2006 and published as GB 2433386A, and UK Patent Application No. 0711782.3, filed Jun. 18, 2007 and published as GB 2444798A, all of which are incorporated herein by reference.

### FIELD OF THE INVENTION

This invention relates to communications devices comprising near field RF communicators.

### BACKGROUND OF THE INVENTION

There is an increasing need for devices and systems to which data formats can be easily uploaded, retrieved and used. For example, in the transport area the ability to buy transport tickets “over the air” and to easily validate and use such tickets is of increasing interest. However the ability to achieve this is complicated by the requirement for security in the data being transferred and used and the number of potential data variants which may be required.

Near field RF (radio frequency) communication is becoming more and more commonplace as is the use of such technology to transfer data. Near field RF communicators communicate through the modulation of the magnetic field (H field) generated by a radio frequency antenna. Near field RF communication thus requires an antenna of one near field RF communicator to be present within the alternating magnetic field (H field) generated by the antenna of another near field RF communicator by transmission of an RF signal (for example, a 13.56 Mega Hertz signal) to enable the magnetic field (H field) of the RF signal to be inductively coupled between the communicators. The RF signal may be modulated to enable communication of control and/or other data. Ranges of up to several centimeters (generally a maximum of 1 meter) are common for near field RF communicators.

In this invention the term near field RF communicator means either: an initiator near field RF communicators such as RFID transceivers or readers that are capable of initiating a near field RF communication but not responding to initiation of a near field RF communication by another near field communicator; or a target or responding near field RF communicators such as RFID transponders or tags that are capable of responding to initiation of a near field RF communication by another near field communicator but not of initiating a near field RF communication with another near field RF communicator. Near field communicators more generally may also include so called ‘NFC devices’ or ‘NFC communicators’ which are capable of both initiating a near field communication and responding to initiation of a near field communication, i.e., acting as both a target and initiating device. A description of an NFC communicator can be found in co-pending application number GB 0625093.0 (UK Published Patent Application No. GB 2433386A) and the corresponding U.S. Patent Application No. 11/640439, filed Dec. 15, 2006, the whole contents of which are hereby incorporated by reference. Depending on the type of near field RF communicator, such near field RF communicator may be able to communicate with an NFC device.

There are several standards in existence which set out certain communication protocols and functional requirements for near field RF communications. Examples are ISO/IEC 14443 and ISO 15693.

There are many applications areas for near field communication that involve transactions with another party or service provider. Such transactions may or may not involve a financial component and may or may not involve a product. One application area is the financial transaction area which involves payment for products such as goods and services. Another transaction area (that may or may not involve a financial element) is provision of products such as access or entry permits such as, for example, tickets or passes.

### BRIEF SUMMARY OF THE INVENTION

An embodiment provides an electronic proof device comprising control means and memory means storing an operating system, at least one application platform configured to run on the operating system, the at least one application platform having at least one application layer for electronic proof data. In a preferred embodiment the device is a secure element, for example, a smart card, SIM card, SD card or other secure or trusted device.

In a preferred embodiment the device provides a transport platform operable to enable an NFC communicator to communicate transport data in accordance with or compatible with ISO/IEC 14443. In an embodiment the secure element provides a platform operable to enable an NFC communicator to communicate data in accordance with or compatible with ISO/IEC 15693.

An embodiment provides a device having a secure element/electronic proof and a near field RF communicator where communication of secure data from the secure element/electronic proof is effected by the near field RF communicator in accordance with its protocols so that the manner in which the secure data is made secure (for example, a manner of encryption) is not known to and is not relevant to the near field RF communicator, but rather the near field RF communicator is operable to supply the secure data via near field communication to another near field RF communicator or NFC communicator which may either have the functionality to decrypt the secure data or more likely will supply the secure data to another device which has that capability. This means that the near field RF communicator does not need to be a secure or trusted device, only the secure element and the device that decrypts communicated secure data need to be trusted devices. This enables a user to carry out a transaction with a third party via near field communication which should not depend upon the particular near field RF communicator to which they have access, the particular transaction or the particular third party involved in that communication, thereby enabling interoperability to maintain a consistent and viable user experience. An embodiment may also provide flexibility and backwards compatibility with existing systems and devices because the near field RF communication is not reliant on the type of secure element or the manner in which it secures its data. Rather the near field communicator communicates the secured data to a near field RF communicator without any knowledge of these features of the secure element. In an embodiment the near RF communicator may be an RF transceiver or an RF transponder.

An embodiment provides a communications device with a near field RF communicator having a coupler to couple with a coupler of a near field RF communicator/NFC communicator in near field range to enable communication of data between the communicators by modulation of a magnetic field. The device also has at least one secure element or electronic proof separate from the near field RF communicator to provide secure data storage for transaction data representing or relating to a transaction. A controller controls operation of the near field RF communicator, reads transaction data from the at least one secure element and causes the modulator to modulate an RF signal in accordance with transaction data read from the at least one secure element so as to communicate the read transaction data to a near field RF communicator or NFC communicator in near field range as proof of the transaction to enable an action related to the transaction to be carried out.

The transaction data may, for example, comprise at least one of: payment data; purchase data; product data; ticket data; reservation data.

An embodiment provides a device having a secure element or electronic proof to enable transfer of data from a memory store of the secure element or electronic proof directly or indirectly to a near field RF communicator wherein such near field RF communicator: is operable to communicate with an external near field RF communicator or NFC communicator through modulation of a proximal H field; is controlled in accordance with instructions received from a controller (for example, a microprocessor, microcontroller or reduced instruction set computer) that may be integral to the near field RF communicator or within a larger host device or system; comprises a modulator to modulate a proximal H field; wherein in operation as a result of communication with the other or external near field RF communicator or NFC communicator, data from the secure element is transmitted to the other or external near field RF communicator or NFC communicator.

In an embodiment, a near field RF communicator: is operable to communicate with an external near field RF communicator or NFC communicator through modulation of a proximal H field; is controlled in accordance with instructions received from a controller (for example, a microprocessor, microcontroller or reduced instruction set computer) that may be integral to the near field RF communicator or comprised within a larger host device or system; wherein in operation data communicated by the NFC communicator is held either wholly or partially within a secure element or electronic proof separate from the near field RF communicator, for example, a SIM card, SD card or other secure memory storage.

In an embodiment, a smart card is provided which comprises a secure element or electronic proof and a near field RF communicator as described above. In a preferred embodiment the near field RF communicator is an RFID transponder or transceiver. In an embodiment the smart card is provided which is operable to enable at least one of (a) viewing of at least some of the data stored on the secure element or electronic proof; (b) modifying at least some of the data stored on the secure element or electronic proof; (c) selecting which data stored on the secure element or electronic proof is transferred to an external near field RF communicator or NFC communicator.

In an embodiment, a mobile telephone or PDA or lap top is provided which: is operable to receive data from a secure element or electronic proof; comprises a near field RF communicator; and has a processor to control transmission of data by the near field RF communicator to another or external near field RF communicator or NFC communicator, wherein the data being transferred is stored wholly or partially on the secure element or within the electronic proof.

In an embodiment, a mobile telephone or PDA or laptop is provided which is operable to receive data from a secure element and is operable to transfer data to another or external near field RF communicator or NFC communicator via a near field RF communicator, the data to be transferred being stored wholly or partially on a secure element or within an electronic proof as described above.

In an embodiment, a mobile telephone or PDA or laptop is provided which is operable to enable the viewing of at least some data stored on a secure element by the mobile telephone or PDA or laptop user and to enable deletion of data from the secure element by the mobile telephone or PDA or laptop user and wherein data on the secure element may be transmitted to another or external near field RF communicator or NFC communicator via a near field RF communicator within the mobile telephone or PDA or lap top.

In an embodiment, a secure element has compatibility with standards requirements and protocols whilst being cost effective and flexible to implement.

In an embodiment, a secure element, for example, a SIM card, USIM card, WIM card, SWIM card, SD card, SMC card or other form of secure element, is operable to transfer data from its memory or data store to an external near field RF communicator or NFC communicator through a near field RF communicator. A secure element may be removable from or fixed or integrated within a larger device or host system, for example, a mobile telephone, PDA, lap-top or other electrical device. As used herein “secure element” means any element which is capable of being used and is “trusted” to hold secure encrypted information and/or data, although not all of the data held by the secure element need be encrypted.

Generally, the secure data is transaction data providing or associated with details of a transaction. The secure data may also comprise access codes or authorization codes. As used herein a “transaction” may or may not be a financial transaction. A transaction may be a purchase of a product such as goods or services, a ticket or access pass such as a transport ticket, for example, an airplane, train, underground, bus, tram, boat, etc. ticket, a ticket for an attraction such as a sporting or other entertainment event, a cinema or theatre ticket, a reservation or booking such as a hotel reservation, a hire car reservation, or a restaurant reservation, or a financial product such as a credit or debit card or monetary amount and so on. In an embodiment, transaction data stored by the secure element or electronic proof comprises transport data, more particularly data representing a product such as a transport ticket, a journey or payment for a journey. In an embodiment transaction data stored by the secure element or electronic proof comprises access data, more particularly data entitling the user of the device comprising the secure element or electronic proof to have access to a building, location or area.

### BRIEF DESCRIPTION OF DRAWINGS

Further features and advantages of the invention will become apparent from the following description of embodiments of the invention, given by way of examples only, which are made with reference to the accompanying drawings, in which:

FIG. 1 shows a functional block diagram of a device embodying the invention;

FIG. 2 shows an example of a memory map of a secure element;

FIG. 3 shows an example of a device embodying the invention;

FIGS. 4 and 5 show representational diagrams illustrating two different devices embodying the invention and comprising near field RF communicators;

FIG. 6 shows a functional block diagram of an example near field RF communicator;

FIG. 7 shows an example of a device embodying the invention comprising an RF transponder;

FIG. 8 shows a flow chart for illustrating operations of a device embodying the invention during installation of a secure element;

FIG. 9 shows a flow chart for illustrating operations of a service provider to install an applications platform on a secure element of a device embodying the invention;

FIG. 10 shows a diagram to illustrate use of a device embodying the invention carrying a secure element storing transaction data such as ticket;

FIG. 11 shows a flow chart for illustrating operations carried out by a secure element near field reader and a device embodying the invention carrying a secure element storing transaction data such as ticket while FIG. 12 shows a ticket structure;

FIG. 13 shows a flow chart for illustrating operations carried out by a device embodying the invention to delete data such as transaction data under user control;

FIG. 14 shows a simplified diagram of another example of a device embodying the invention having two or more secure elements; and

### DETAILED DESCRIPTION

With reference to the drawings in general, it should be understood that any functional block diagrams are intended simply to show the functionality that exists within the device and should not be taken to imply that each block shown in the functional block diagram is necessarily a discrete or separate entity. The functionality provided by a block may be discrete or may be dispersed throughout the device or throughout a part of the device. In addition, the functionality may incorporate, where appropriate, hard-wired elements, software elements or firmware elements or any combination of these. Also, a device may be provided wholly or partially as an integrated circuit or collection of integrated circuits.

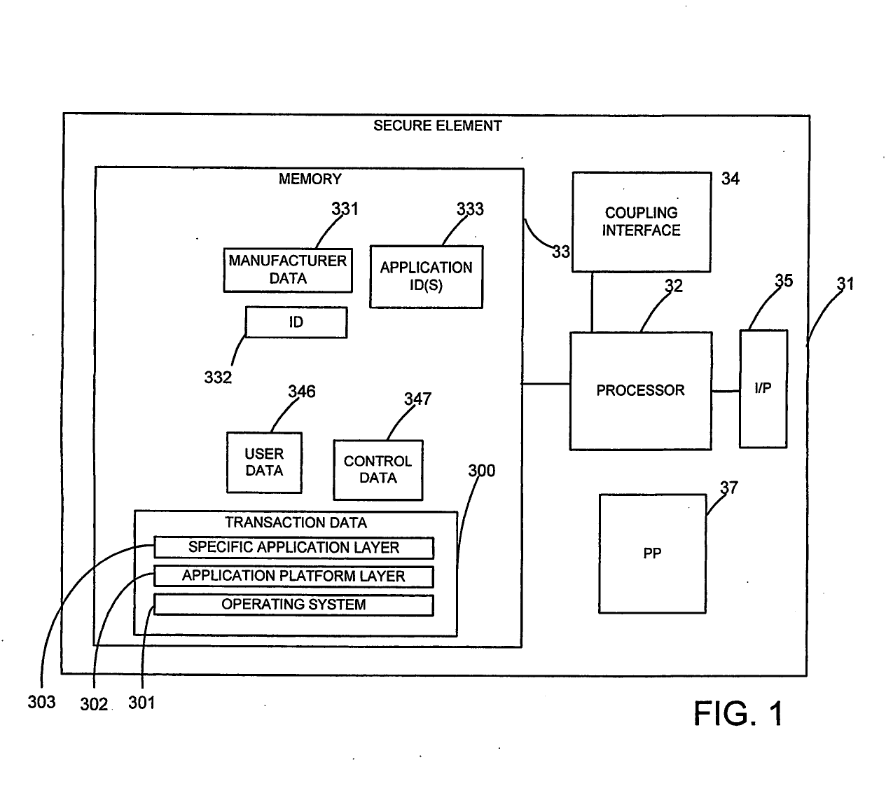

FIG. 1 shows a block diagram of an example of a secure element 31. The secure element comprises a memory area 33, a controller 32 (which may be a microprocessor, microcontroller or state machine, for example) which controls the functionality of the secure element in accordance with the data stored within the memory area 33. Generally, the memory area 33 and controller 32 will be provided within an integrated circuit. The memory area 33 may be any type of suitable memory or combination or types of memory but preferably comprises non-volatile memory, for example, EEPROM or flash memory (or battery-backed up volatile memory) for data that requires long term storage. The memory area 33 may also include volatile memory for data that is only required while power is supplied to the secure element 31. The secure element may be, for example, a SIM (Subscriber Identity Module) or USI (Universal Subscriber Identity Module), an SD (Secure Digital) card or a miniSD card.

The secure element may be a stand-alone device or intended to be comprised within or used together with a larger device or host system. For example, where the secure element comprises a SIM card, it may be intended for use within a mobile telephone. In such an example the SIM card will have connections (not shown) to functionality within the mobile telephone. Where the secure element comprises a removable storage device, such as a memory card or SD card, the user will insert such a device into a mobile telephone, PDA or laptop for example. Coupling interface 34 on the secure element will enable the secure element to interface with the mobile telephone, PDA or laptop controller and generally also derive operating power from the mobile telephone, PDA or laptop power supply.

The secure element may however be any appropriate storage element having processing capability to enable the secure element 31 to communicate (send and receive) secure data (that is encrypted data) and to store data in a secure encrypted manner to inhibit reading of or tampering with the secure data by an unauthorised device or person or unauthorised functionality. The secure element may also be able to communicate and store unencrypted data, such as data that is freely publicly available or user data that the user does not consider to be private data.

In the alternative, where none of the data being stored on the memory area 33 is encrypted or needs to be encrypted, only unencrypted data may be stored by the secure element.

The secure element 31 also has a coupling interface 34 (connections not all shown) comprising one or more coupling elements which may be electrical contact elements but could be wireless or contactless coupling elements, for example, capacitive, inductive or electromagnetic coupling elements. The coupling elements may, for example, be in compliance with ISO 7816. The secure element 31 also has a power provider (PP) 37 which may be a power supply such as a battery or cell within the secure element or may simply be a coupling to a power supply of a host device or other power source.

Other examples of possible secure elements are encrypted smart cards, memory cards, encrypted multi-media cards, WIM (WAP Identity Module or Wireless Identity Module) cards, SWIM (Subscriber WAP Identity Module) cards, SMC (Smart Media Card) card or any other form of secure element that is capable of storing data in a secure manner.

Where the secure element is comprised within a stand-alone device, e.g., a smart card or memory card, the device may additionally comprise a user interface. For example, the smart card or memory card may comprise a display on which data stored on the secure element can be viewed by a user of the device. Such a display may comprise one or more of lights or light emitting diodes, for example, showing status of power supply, whether a transaction is in effect or whether a transaction has finished. As another possibility or additionally, the display may be a full text display or screen. The device may comprise a user input mechanism by which the user can modify and/or delete and/or select data comprised within the secure element. For example, the device may comprise at least one of a touch-sensitive screen, one or more buttons, keypad or other suitable user interface.

As described above such coupling interface 34 may enable coupling with a larger device or host system. In the alternative (for example, where secure element forms part of a stand-alone device) or additionally, such coupling interface may comprise a communicator for communicating data from the secure element to an external device and for receiving data from an external device. Such a communicator may be, for example, a near field RF communicator.

As shown in FIG. 1, the memory area 33 has a manufacturer data region 331, a secure element ID data region 332, an application ID(s) data region 333 and a transaction data region or electronic proof 300. The memory 340 may also include a user data region 346 and control data region 347. The nature of the data stored by the memory store 33 of the secure element will depend upon the intended application or use of the secure element but will generally include control data to enable the secure element to interface with an external device through the coupling interface 34, for example, communication protocol details. The memory area 33 or processor 32 may also comprise data required for encryption and decryption of data stored within memory 33. For example, the encryption system may be a public-private key encryption system in which case the memory 33 may hold a private key or keys. As an alternative the encryption system may be based on a secure algorithm in which case the memory 33 or processor 32 may hold the secure algorithm.

In this example, the electronic proof is configured to have a layer or protocol stack structure 300 such that the operating system 301 “sits beneath” an applications platform layer 302 and specific applications 303 are loaded “on top” of the relevant applications platform layer 302.

As an example, the application platform layer 302 may provide at least one of a: 1) a banking applications platform defining payment protocols in accordance with banking standards and procedures (including credit card requirements, EMV specifications and the like); 2) a transport applications platform defining transport protocols in accordance with ISO/IEC 14443; 3) an access applications platform defining access protocols in accordance with ISO/IEC 15693. One or more other, for example, proprietary, applications platforms may also be included, for example, the supplier of the secure element may customise the secure element in some fashion or provide additional functionality. A specific applications platform (or possibly more than one if a transaction involves for example, separate payment authorisation) will be involved in each transaction. The applications platform layer 302 “sits beneath” a specific application layer 303 which will have, for each applications platform, corresponding instances of transactions using that applications platform and storing data in configurations specific to that instance. For example, where the applications platform layer 302 has a transport applications platform or protocol then the specific application layer 303 may store a distinct memory map for each transport transaction, where a transport transaction will usually be an electronic equivalent of a ticket or travel pass and may be a single, return, multiple journey, season ticket and so on. For example, for a particular transport applications platform or protocol then the specific application layer 303 may have data representing different types of purchased tickets, for example, data for single journey tickets may be included together with data representing season tickets.

The different areas of the memory area 33 may have different levels of access depending upon what or who is trying to access them. For example, some areas may be programmable or writeable to only by certain authorized entities and other entities may only read data from those areas, while other areas may be writeable to once by some entities but writable to more than once by other entities and some areas may be freely writeable. For example, the manufacturer data region 331 may be writeable to only by a manufacturer so that only the manufacturer can provide, replace or modify that data, the secure element ID data region 332 may be writeable to only by the provider of the secure element. The application ID(s) data region 333 may be writeable to only by the appropriate applications platform. Transaction data area 300 may be readable by a user of the device but not modifiable by that user. As another possibility, specific transaction data 303 may be stored by the secure element so that it can be read by a user or deleted in its entirety by a user but not modified by a user. The actual levels of access provided for a particular region or area will depend upon the nature of the data stored and the secure element.

In this example, the secure element 31 has an operating system 301 and one or more applications platforms 302 each for handling a different type of transaction such as transport, payment and access transactions. Where flexibility is required of a secure element, then the overall operating system and one or more applications platforms 302 may be stored in an area of memory that may be rewritten, that is freely programmable memory. Where flexibility is not required, then the operating system 301 and one or more applications platforms 302 may be stored in an area of memory that may be programmed or written to only once. As another possibility, the operating system 301 may be stored in an area of memory that may be programmed or written to only once, and the one or more applications platforms 302 may be stored in freely programmable memory.

The access level for an area of memory may be controlled by software, for example, the secure element operating system or applications platform. As another possibility, memory that is intended to be accessed only by a manufacturer may be one time programmable (OTP) programmable, in known manner, at mask level or by fusing of a fuse for example.

Generally, the applications platform(s) will be stored in area(s) of memory for which the operating system encrypts data for security and from which the operating system only allows secure, encrypted (for example, public private key encryption using a private key or keys or secure algorithm securely stored by the secure element) data communication. The user data area may have secure data and insecure data storage areas, for example. The type of memory provided for a particular purpose and the level of security (encryption) or lack of security for that data will depend upon the particular application of the secure element. Providing both one time programmable or writeable memory and freely programmable memory enables flexibility in commands (because modifications and/or replacement data and software may be downloaded to the freely programmable memory) and can also be used to generate additional security or functionality.

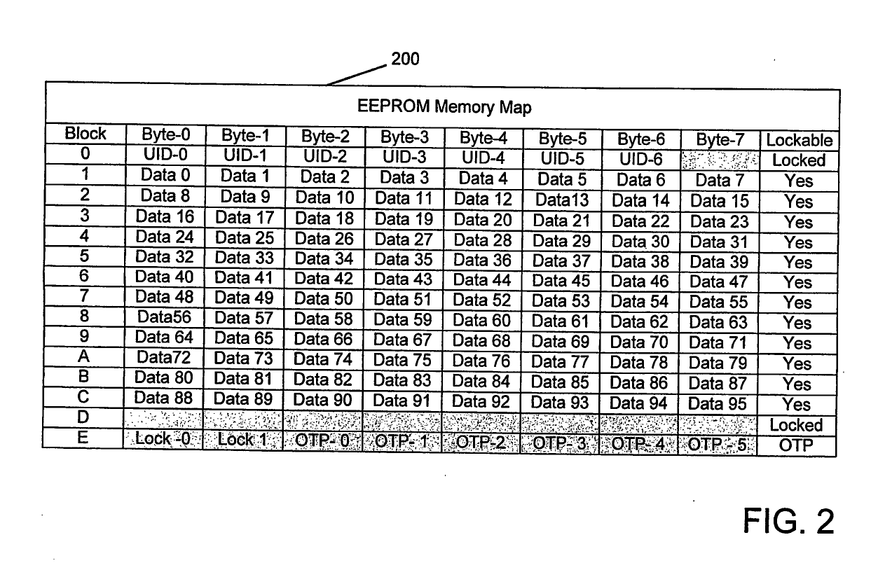

In this example, the data for a transaction (such as a ticket) is stored as a memory map on the relevant application platform layer 302. An example memory map or array 200 is shown in FIG. 2. The memory map 400 illustrated in FIG. 2 represents an example of a limited use transport ticket compatible with ISO/IEC 14443A.

The memory map shown in FIG. 2 comprises as an example 120 bytes of EEPROM (Electrically Erasable Programmable Read Only Memory) arranged as 15 blocks of 8 bytes with each block being separately lockable generally by software as described above to prevent overwriting.

In the example shown in FIG. 2, the memory map also has a 2-byte header that forms part of the applications platform layer 303 (FIG. 1), is unique to that applications platform and can not be altered once programmed, unless, in a preferred configuration, the entire memory map and thus the transaction (ticket in this example) in its entirety is deleted. The header identifies the specific transaction, for example, a specific ticket.

In the example illustrated in FIG. 2, the block (or row) usage within the memory map is configured such that:
Block 0 is reserved for a 7 or 8 Byte UID (Unique Identification) which is programmed when the transaction is stored in the memory.
Blocks 1-C: (all 96 data bytes) are available to the transaction provider. These blocks can be programmed with, for example, application data, user data, control data. These blocks may also be written to or changed during operation of the NFC communicator, for example, data may be written to these blocks as a result of communication between the NFC communicator and another near field RF communicator.
Block D: Least significant 4 bytes are reserved for use or future use by the secure element, its manufacturer or distributor.
Block E: In this example, the least significant 2 bytes are used to store and control the block-lock status. The most significant 6 bytes are available for use by the transaction provider.

The programmable part or usable area of the memory map may be expanded to permit at least one of additional memory capability and additional command protocols or structures. For example, the memory map may be extended to 192 bytes by adding 12 further 8 byte blocks or to 384 bytes by adding an additional 24 further 8 byte blocks.

It will of, course, be appreciated that this is only an example memory map and that the number of blocks and the number of bytes within a block may differ.

The operating system may be installed at manufacture of the secure element. As another possibility, the operating system may be downloaded via near field RF communication (where the secure element has access to a suitable near field RF communicator) from another near field RF communicator or NFC communicator. As an example, such a preloaded secure element or transponder may be purchased or given away with a larger or host device. As another possibility, the operating system may be stored in a memory of a larger system or host device and downloaded to the secure element upon insertion into the device. As another possibility, the operating system may be downloaded, for example, via the Internet, via communications functionality of the device (either directly via a coupling interface 34, FIG. 1 or indirectly via a larger host system or device. For example, where the secure element forms part of or can be inserted into a mobile telephone, the operating system may be downloaded to the secure element via the mobile telecommunications system. In one example, the operating system may be provided as a JAVA applet. As another possibility, the Symbian operating system may be used. Where a mobile telephone is concerned, then a JAVA MIDlet may be used. Upgrades or modifications of the operating system may be supplied by any of these means. Where the operating system is stored in the memory store 33 during production or manufacture, then the operating system may require activation by a user of the secure element prior to operation.

The applications platforms (302 in FIG. 1) may be provided in any of the ways available for provision of the operating system. As an example, an applications platform may be provided as a JAVA (Registered Trade Mark of Sun Microsystems)—enabled applet where a JAVA based or compatible operating system is used.

The actual transactions (303 in FIG. 1) may be provided in any of the ways available for the operating system and applications platforms. For example, the secure element may be pre-loaded with the transaction or, for example, as a selling point, one or more transactions may be provided with the secure element or other product (within which the secure element is comprised). Other transactions or modified transactions may then be provided as described above for the operating system and applications platform layers. Where the transaction is pre-loaded, then the UID (FIG. 2) will be programmed into the memory of the secure element during manufacture or production. Where the transaction is supplied at distribution or point of sale of the secure element (or host device), then the UID will be programmed in at that time. Where the transaction is a ticket such as a transport ticket, then the UID will be programmed when the ticket is purchased and downloaded to the secure element, i.e., at point or time of sale. As an example, a ticket may be purchased via the Internet and then downloaded to the device at a local outlet by, for example, near field RF communication or other communications channel available to the device.

As described above, the secure element in FIG. 1 may receive and communicate data via near field RF communication. The near field RF communicator may be comprised within the secure element (for example, form part of coupling interface 34) or be separate from the secure element (for example, form part of a larger device or host system). The near field RF communicator to which the secure element has access may be, for example, an RF transponder or RF transceiver. Where the near field RF communicator is an RF transponder it will be able to communicate with compatible external RF transceivers or NFC communicators. The RF transponder may be active (have its own power supply) or passive (derive at least part of its power supply from a received magnetic or H field). Where the near field RF communicator is an RF transceiver, it will be able to communicate with compatible external RF transponders and NFC communicators. Where an external near field RF communicator or NFC communicator is compatible will depend on the communication protocols each is able to operate under.

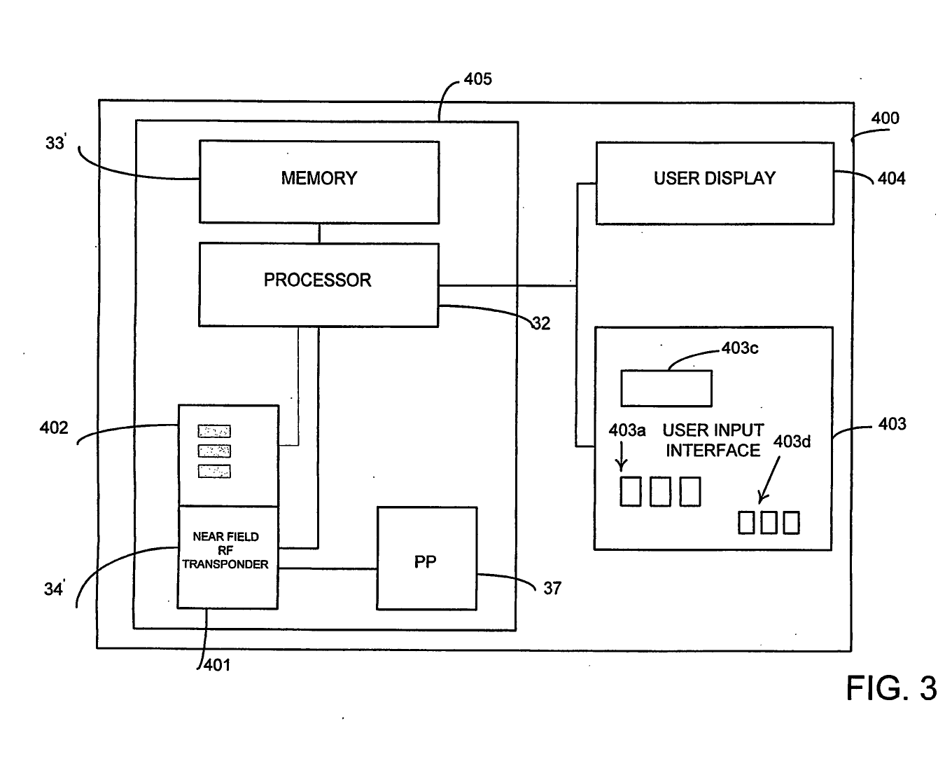

FIG. 3 shows a representational diagram of a device 400 embodying the invention comprising a secure element 405 (for example, the secure element shown in FIG. 1) operable to communicate and receive data via a near field RF transponder. The device is in the format of a laminated card or card shaped format, for example, similar to a smart card or credit card. The device comprises a user display 404 on which certain data from the memory 33 can be displayed, for example, specific application data representing the number of transport tickets stored on the device 400. The device also comprises a user input interface 403 which may have, for example, any one or any combination of one or more mechanical buttons 403a, a touch-sensitive screen 403c (which may also be the display 404) and one or more light emitting devices 404d to enable the user to enter a pin number to access the device and then to select the transaction data he/she wishes to use or transfer to an external device.

The device may be a label, electronic token, transport ticket or access card

The secure element comprises memory 33′, for example, in similar format to that described for memory 33 in FIG. 1. The memory 33′ is configured to store transaction data in the form described above, namely an electronic proof with a series of layers, operation system layer, an application platform layer and a specific applications layer. Part or all of the transaction data may be held in secure or encrypted format.

The secure element will also comprise a processor or controller 32 (as described for FIG. 1) and a power provider 37. The power provider may be as described for FIG. 1, as another possibility power may also be derived via coupling between the near field RF transponder 401 and an external near field RF communicator or NFC communicator. Power derived by the transponder 401 as a result of coupling with an external near field RF communicator or NFC communicator may be wholly or partially used to power the operational elements of the secure element. As another possibility, any power may be used solely to power the transponder. The secure element 405 also comprises a coupling interface 34′ which comprises a near field RF communicator (in this case an RF transponder) and a contact interface 402. The contact interface is used, for example, to insert the device 400 into a larger system or device. The RF transponder 401 is, for example, used by the device 400 to receive and transmit data from the memory 33′ wirelessly. Example of this communication is given further below.

As described above, the transaction data or any part of the transaction data (for example, the operating system) may be present on manufacture of the device 400 or secure element 405 or may be downloaded after manufacture. For example, such data may be downloaded to a laptop from the internet and then loaded onto the device 400 via either the contact interface 402 or near field RF communicator 401. As another possibility, the device may be loaded into a mobile phone and the data downloaded to the device via the mobile telecommunications network. Or the data may be ordered by telephone or through the internet and then loaded onto the secure element 405 via a specific terminal, through either the contact interface 402 or near field RF communication 401.

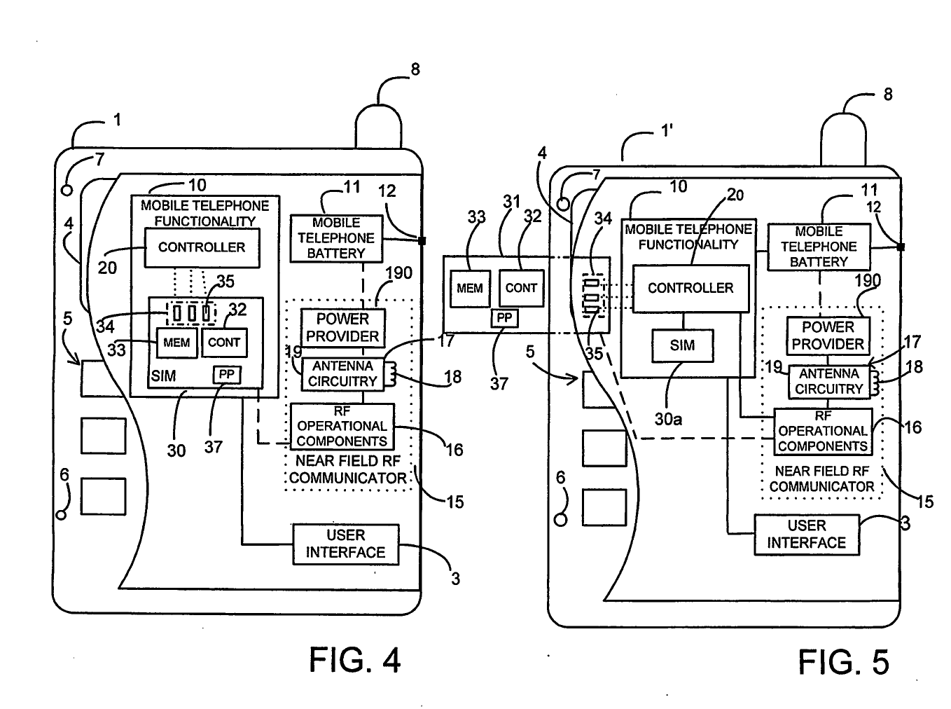

Referring now specifically to FIGS. 4 and 5, there are shown representational diagrams of devices 1 and 1′ embodying the invention each comprising a secure element (30 in FIG. 3 and 31 in FIG. 4), a near field RF communicator 15 to communicate data stored by the secure element 30 or 31 to another near field RF communicator or NFC communicator by modulating the H (magnetic) field of an RF signal. The devices may also comprise additional functionality (device functionality) 10 and a user interface 3.

The secure element 30 or 31 is in similar form to that described for FIG. 1 above and is configured to be programmed or is already programmed with an operating system and one or more applications platforms to enable the secure element to load a corresponding application to enable a transaction to be effected such as at least one of payment for products such as goods and/or services and purchase or acquisition of ticket data, permit data, pass data or access data. Where the data is held as secure data (for example, payment data or ticket data), the secure element is capable of encrypting and possibly also decrypting data. This may be achieved using, for example, a public-private key encryption system, with a private key or keys being securely held by the secure element. Neither a controller 20 of the device 1 or 1′ nor the near field RF communicator 15 needs to be configured to handle that particular type of transaction, but simply needs to be able to communicate data with the secure element 30 or 31. Thus, neither the device nor the near field RF communicator needs to have any information about the encryption algorithm used by the secure element or to have any other information concerning the manner of secure data provision; they simply need to be able to cause the secure data to be communicated by near field communication. The receiving near field RF communicator or NFC communicator, or more likely a secure device associated therewith, will carry out the necessary decryption of the secure data. Therefore, only the secure element and the receiving device that carries out decryption need to be devices trusted to effect secure data communication and storage. The types of transactions that can be handled by the device 1 or 1′ are determined by the applications platform or platforms loaded onto the secure element 30 or 31 and these may be modified, updated or replaced by changing the secure element (where it is removable) and/or, where the secure element permits, reprogramming the secure element by downloading modified or replacement applications platforms via, for example, a communications system of the device 1 or by near field RF communication between the near field RF communicator 15 and another near field RF communicator or NFC communicator. The transaction data may be obtained in any of these ways. It may also be possible to obtain data, for example, transaction or product data via the Internet and then download the product data by, for example, near field RF communication from a local outlet, for example, in a manner similar to that in which cinema tickets can be purchased over the Internet and the ticket then printed out at the cinema when the credit card used to purchase the ticket is read.

In the examples shown in FIGS. 4 and 5, the secure element is coupled to a controller 20 of the device 1 to enable communication of data between the controller and the secure element 30 or 31 and the controller 20 is coupled to the near field RF communicator 15 to enable communication of data between the controller 20 and the NFC communicator 15.

In FIGS. 4 and 5, the representations of the devices 1 and 1′ have been shown partly cut-away and the functionality provided by the device 1 or 1′ illustrated by way of a functional block diagram within the device 1 or 1′.

In the examples shown in FIGS. 4 and 5, the devices 1 and 1′ are mobile telephones (cellular telephones or “cellphones”), although the device may be any suitable portable (user-carryable) user device such as, for example, a portable computing device, for example, a PDA or laptop.

In the examples of FIGS. 4 and 5, the devices 1 and 1′ have the usual features of a mobile telephone including mobile telephone functionality 10 comprising the controller 20 mentioned above (generally a processor or microprocessor with associated memory or data storage), for controlling operation of the mobile telephone, an antenna 8 for enabling connection to a mobile telecommunications network, and a user interface 3 with a display 4, a keypad 5, a microphone 6 for receiving user voice input and a loudspeaker 7 for outputting received audio to the user. The mobile telephone also has a chargeable battery 11 coupled to a charging socket 12 via which a mains adapter (not shown) may be connected to enable charging of the battery 11.

In addition, as mentioned above, the devices 1 and 1′ each have a near field RF communicator 15. In FIGS. 4 and 5 the near field RF communicators comprise RF transceivers.

Each near field RF communicator 15 comprises RF operational components 16 for, as will be described below, enabling control of the near field RF functionality and generation, modulation and demodulation of an RF signal. Each near field RF communicator 15 also comprises a coupler 17 comprising an inductor or coil in the form of an antenna 18 and antenna circuitry 19 to generate an RF signal at, for example, 13.56 MHz. The couplers 17 enable inductive coupling of an alternating magnetic field (H field) generated by the antenna of the near field RF communicator 15 by transmission of an RF signal (for example, a 13.56 Mega Hertz signal) to the antenna of another near field RF communicator or NFC communicator (for example, an RF transponder) when that antenna is within the near field of the RF signal generated by the near field RF communicator 15.

In each of FIGS. 4 and 5, the near field RF communicator 15 is coupled to the mobile telephone functionality 10 to enable data and/or control commands to be sent between the near field RF communicator and the host device and to enable user input to the near field RF communicator. Communication between the user interface 3 and the near field RF communicator 15 is via the host device functionality 10.

Each near field RF communicator 15 also comprises a power provider 190. The power providers 190 may be power supplies within the host device or specific to the near field RF communicators 15, for example, a button cell battery, or other small battery. As another possibility or additionally as shown by dashed lines in FIGS. 4 and 5, the power providers 190 may simply comprise a coupling to derive power from the corresponding device battery 11.

The processing power provided by the secure element 30 or 31 will depend upon the particular secure element and how it interacts with the controller of the device 1 or 1′ or the near field RF controller. For example, the secure element may carry out only limited processing specific to the applications software, for example, encryption and/or decryption of secure data and other processing may be carried out by the controller 20 or the near field RF controller.

In the example shown in FIG. 4, the secure element 30 is provided by the SIM (Subscriber Identity Module) or USIM (Universal Subscriber Identity Module) of the mobile telephone while in the example shown in FIG. 5 the secure element 31 is an external memory device receivable in a memory slot of the mobile telephone, for example, a SD (Secure Digital) card or miniSD card, and is separate from the SIM card 30a.

In the example shown in FIG. 4, the secure element 30 comprises a SIM card which may be provided already in place in the mobile telephone or is inserted prior to activation of the mobile telephone. The SIM card remains in place during mobile telephone operation and is not generally removed by the user. The SIM card has connections (not shown) to other functionality within the mobile telephone and as with the SD card interfaces to the mobile telephone controller 20. In contrast, in the example shown in FIG. 5, the secure element 31 comprises a removable secure element such as an SD card and a user will insert the secure element 31 into the mobile telephone (as and when the user wishes to use the data stored on the secure element or wishes to provide for additional data storage), so that the contact elements of the secure element enable the secure element to interface with the mobile telephone controller 20 and generally also to derive operating power from the mobile telephone power supply 11.

The secure element 30 or 31 may however be any appropriate storage element having processing capability to enable the secure element 30 or 31 to communicate (receive and send) data and to store data in a secure manner to inhibit reading of or tampering with the data by an unauthorised device or person or unauthorised functionality. The secure element may also be able to communicate and store unencrypted data, such as data that is freely publicly available or user data that the user does not consider to be private data.

FIGS. 3, 4 and 5 thus show different examples of devices in accordance with the invention.

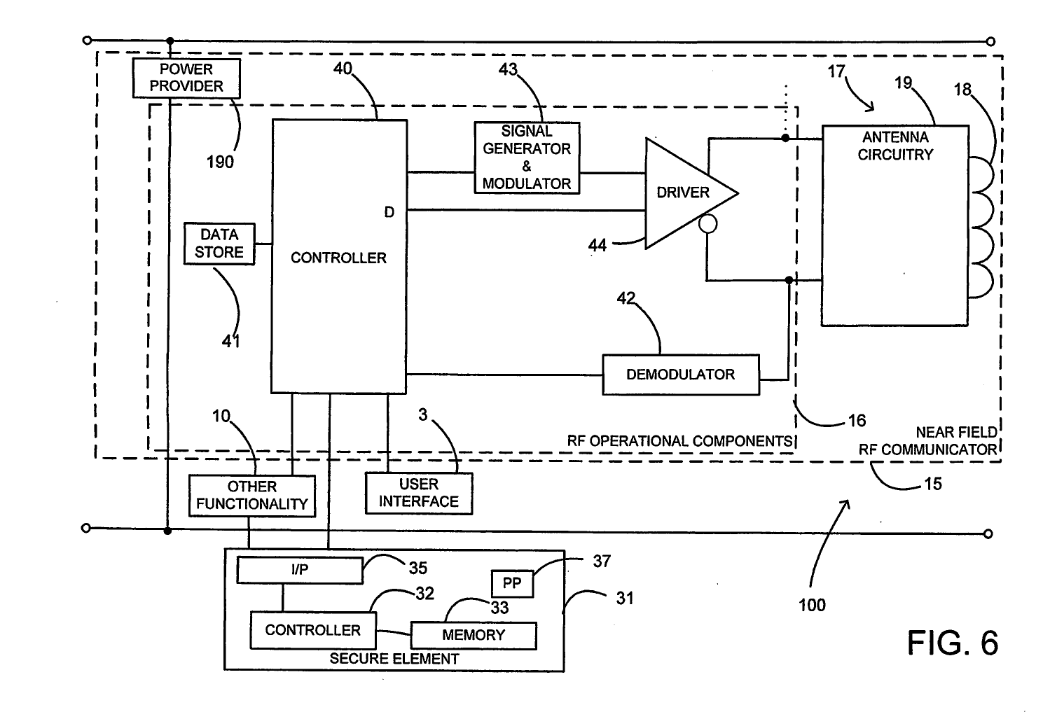

FIG. 6 shows a functional block diagram of a device 100 in accordance with this invention (such as the mobile telephone shown in FIG. 5 that is capable of receiving a secure element in addition to its SIM card) to illustrate in greater detail one way in which the near field RF operational components of a device embodying the invention may be implemented to provide a near field RF communicator which is capable of either initiating near field communication or responding to initiation of near field communication, but not both.

As described above for FIGS. 4 and 5, a device comprises a near field RF communicator 15 (in this case an RF transceiver) having RF operational components 16, an inductive coupler 17 with an antenna 18 and antenna circuitry 19 and a power provider 190. As discussed above, the power provider 190 may be any one or more of: a coupling to a power supply within the host device; a power supply specific to the near field RF communicator 15, for example, a button cell battery, or other small battery. In the interests of simplicity, power supply couplings from the power provider 190 to other components are not shown in FIG. 6.

As shown in FIG. 6, the device 100 has other functionality 10 (which may be the mobile telephone functionality described above with reference to FIG. 5) and a user interface 3.

The near field RF communicator 15 has a controller 40 to control overall operation of the near field RF communicator either alone or in conjunction with the controller 20 of the device 100 and an associated data store 41 to store data (information and/or control data) to be transmitted from and/or received by the device 100. The controller 40 may be, for example, a microprocessor, for example, a RISC processor or other microprocessor or a microcontroller or a state machine. Program instructions for programming the controller 40 and/or control data for communication to another near field RF communicator or NFC communicator may be stored in an internal memory of the controller and/or the data store 41.

The RF operational components 16 also have a demodulator 42 coupled between the coupler 17 and the controller 40 to demodulate a modulated RF signal inductively coupled to the coupler 17 from another near field RF communicator (for example, an RF transponder) or NFC communicator in near field range and to supply the thus-extracted data to the controller 40 for processing. In addition, the RF operational components 16 have components to enable modulation of an RF signal to allow data to be communicated to another near field RF communicator or NFC communicator in near field range of the near field RF communicator 15. As shown in FIG. 6, these components comprise a signal generator and modulator 43 coupled to one input of a differential driver 44 having its other input coupled to a data output D of the controller 40 to cause the differential driver 44 to output to the coupler 17 signals modulated by the data supplied from the data output D. The modulator is shown as part of the signal generator in FIG. 6, it may instead form part of the controller or form a separate modulation controller block.

The near field RF communicator 15 will be able to communicate with any compatible near field RF communicator or NFC communicator. As thus used, compatible means operable at the same frequency (for example, 13.56 MHz) and in accordance with the same protocols, for example, in accordance with the protocols set out in various standards such as ISO/IEC 14443 and ISO/IEC 15693.

The near field RF communicator may use any appropriate modulation scheme that is in accordance with the standards and/or protocols under which the near field RF communicator operates

The secure element 31 will be as described above and will generally communicate with the other functionality 10 (the controller of the mobile telephone in FIG. 2) of the device 100 but may also, as shown in FIG. 6, communicate with the controller 40 of the near field RF communicator 15.

The block diagram shown in FIG. 6 would differ for the mobile telephone 1 shown in FIG. 4 only in that the secure element would be positioned within rather than externally of the other functionality 10.

The near field RF communicator 15 may communicate data from at least one of: its own internal data store (if present); the data store 41; an internal data store of the mobile telephone host controller; another data store within the device 100. The near field RF communicator 15 is also operable to enable data communication between the secure element 30 or 31 and another near field RF communicator or NFC communicator external to the device via the near field RF communicator 15. Depending upon the applications platform(s) installed on the secure element, data may simply be read from the secure element and communicated by the near field RF communicator 15 to another near field RF communicator or NFC communicator but may possibly also be supplied by another near field RF communicator or NFC communicator to the near field RF communicator 15 to be stored by the secure element. Where appropriate, for example, where transaction data is being communicated, then the data being communicated will be secure data (that is encrypted).

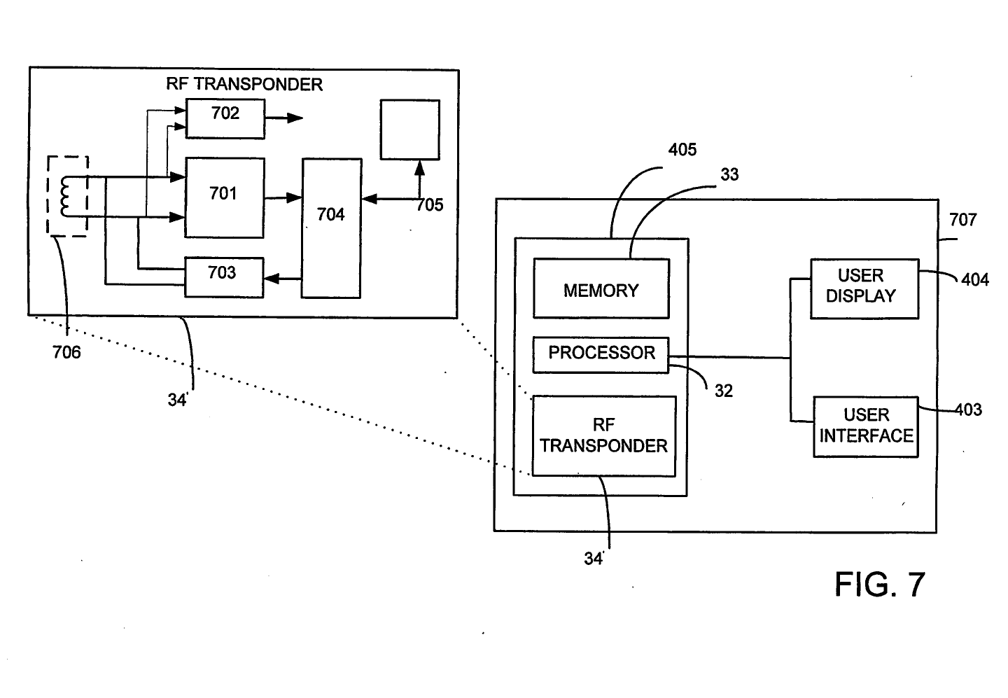

FIG. 7 shows a functional block diagram of a device 400 in accordance with this invention (such as a smart card as shown in FIG. 3) to illustrate in greater detail another way in which the near field RF operational components of a device embodying the invention may be implemented. The device 400 is the same or similar to that shown in FIG. 3 and comprises a user display 404, user interface 403, processor 32 and memory 33. As described above transaction data will be stored within the memory 33, as shown in more detail in FIG. 3. The device also comprises a coupling interface 34′. In FIG. 7, this coupling interface comprises a near field RF communicator in the form of an RF transponder. The functionality of the RF transponder is shown in the inset box in FIG. 7. Thus, as shown, the RF transponder comprises a demodulator 701, a controller (for example, microprocessor, microcontroller or state machine) 704, a modulator 703 and memory 705. The RF transponder also comprises an antenna circuit 706 comprising for example, a coil.

In this example, the near field RF communicator is shown with its own controller 704. The extent of this controller will depend on the amount of processing carried out within the near field RF communicator. As an alternative, all or part of the processing may be carried out by the secure element processor 32. Where all processing is carried out by processor 32, then remaining functional blocks of near field RF communicator will connect directly to processor 32.

When, for example, an RF transceiver causes a magnetic field to be present around antenna circuit 706, a voltage will be generated across such antenna circuit. The RF transponder 34′ may or may not comprise a power deriver 702, which can if present, use the voltage across the antenna circuit to derive a power supply for all or part of the RF transponder or alternatively the device 707. If the supplied magnetic field is modulated, then demodulator 701 demodulates the signal and outputs the demodulated data to controller 704. Controller 704 may respond to data from the demodulator 701, the presence of power from a power deriver 702, or from other stimulus, not shown, and may or may not cause data to be read from or written to the data store 705. Depending on the data received, controller 704 may also request data from the secure element memory 33, for disclosure to the external near field RF communicator or NFC communicator.

Where data is transferred to the external near field RF communicator or NFC communicator, modulator 703 will, cause, according to the data, a modulated signal to be coupled via the antenna circuit 706 to the external near field RF communicator or NFC communicator. Such modulation may be, for example, through load modulation of the antenna circuitry 706.

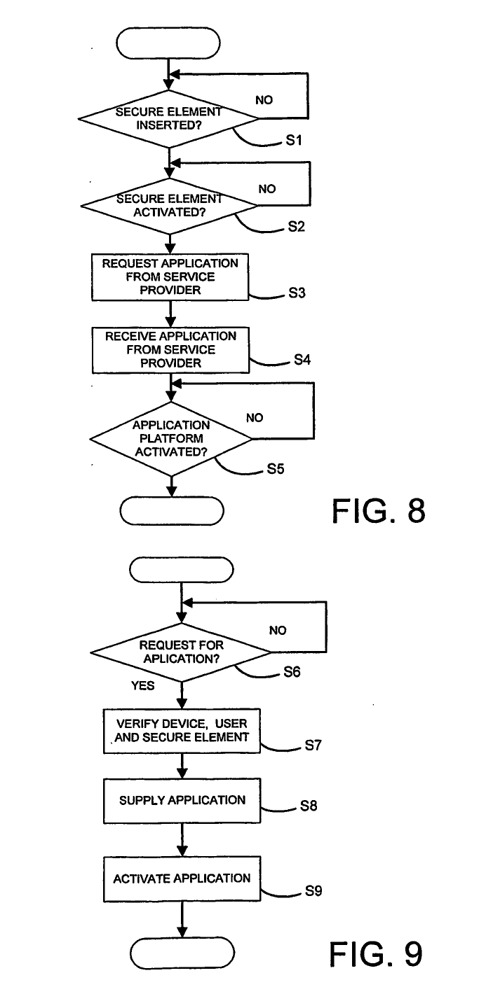

FIG. 8 shows a flow chart representing processes carried out by a device in accordance with the invention to activate a secure element (for example, 30 or 31) or any part of the secure element. Where the device is a mobile telephone and as in FIG. 4 the secure element is a SIM card for the mobile telephone, then the SIM card will carry the usual user and operational data required by the mobile telephone user to operate the mobile telephone. As mentioned above, the SIM card may be provided with the mobile telephone or separately from the mobile telephone. To activate the mobile telephone, the user inserts the SIM card into the mobile telephone and then requests activation. Where the secure element is a different type of secure element, the user may simply insert the secure element to initiate activation. When the mobile telephone detects insertion of a secure element at S1, then the secure element is activated at S2. The activation process will usually require verification of the mobile telephone and user details and the SIM card by the mobile telecommunications service provider via the mobile telecommunications network in order to activate the mobile telephone. The SIM card can now be used as a secure element in accordance with the present invention. Where the secure element is not a SIM card, then insertion of the secure element into an appropriate slot in the device may launch software on the secure element or in the device to activate the secure element.

As another possibility, where the secure element forms part of a stand-alone smart-card or is not associated with any particular device or host system, activation of the secure element or part of secure element may require the user to enter a pass-key or to take the secure element to an activation terminal or equivalent.

As set out above, the secure element (whether a SIM card or other secure element) may be pre-loaded with an applications platform. As another possibility or additionally, at the user's request or as a result of some action by the user, a service provider may be requested at S3 to activate a pre-installed applications platform or download an applications platform onto the secure element. For example, the device user may wish to make payment transactions using his device and may go into a bank to request a suitable payment applications platform to be inserted onto the secure element. As another possibility or additionally, the user may wish to use the device as a credit card and may request that VISA (Registered Trade Mark) or Mastercard (Registered Trade Mark) or some other similar credit card company activates or loads a credit card applications platform (for example, an EMV platform) onto the secure element. As another possibility or additionally, the user may wish to use the device as a ticket or access pass and may request a transport service provider or access service provider to activate a transport applications platform. For example, both a transport applications platform and a payment applications platform may be activated or loaded onto the secure element.

The manner in which the applications platform is activated or downloaded will depend upon the circumstances. For example, an applications platform may be activated or downloaded via the telecommunications network where this is available to the device, or via near field RF communication or NFC communication, or by supply of an activation code that the user keys into their device and so on.

When an applications platform is received at S4, then the device checks for correct activation at S5. Once this has been completed, the secure element and its applications platform are ready for use.

FIG. 9 shows a flow chart illustrating an example of processes carried out by a service provider in response to a request for an application platform. Thus, when at S6 the service provider receives a request for an applications platform, the service provider verifies the device, user and secure element at S7. Verification of the authenticity of the device (which may be a mobile telephone), the user and the secure element may involve the input of pin numbers and/or messages (for example, text messages in the case where the device is a mobile telephone) to which the user must reply. Assuming the verification process is satisfactorily completed, then at S8 the service provider loads the applications platform onto the device using an appropriate JAVA-enabled applet, MIDlet or other software program as discussed above. Once the service provider has determined by communications with the device (via the mobile telecommunications network, wired interface or near field RF communications as appropriate) that the installation has been successful, then it activates the applications platform at S9 to enable the user of the device to carry out a transaction using that applications platform, for example, a payment transaction if the applications platform is a payment applications platform or a transport ticket transaction if the applications platform is a transport applications platform.

As mentioned above, the applications platform may be loaded onto the secure element via the mobile telecommunications network, via a near field RF communications enabled service provider or through a wired or wireless link between the device. Once the application platform has been loaded and activated (S5 in FIG. 8 and S9 in FIG. 9), the service provider has control of that platform and can then use the platform for specific application data applications.

Operation of a device embodying the invention will now be described where the installed applications platform is a transport platform and the user of the device wishes to buy a train or other transport ticket. The ticket itself may be bought, using an installed payments platform, from a service provider via any of the mechanisms mentioned above, for example, via the mobile telecommunications network or via near field communication from, for example, a near field RF communicator at a ticket office or another vending facility, and then installed onto the secure element directly or via the controller 20, depending upon the device architecture. As another possibility, the appropriate vending facility may provide the ticket in the form of data that the user enters via the user interface of the device together with a user or ticket ID or an authorisation code. As another possibility, the ticket may be supplied in the form of a near field RF transponder or tag at a point of sale such as a ticket office or with the device (for example, as a promotional item) and the ticket data then downloaded by near field RF communication to the near field RF communicator (for example, RF transceiver) of the device. As another possibility as discussed above, the ticket may be purchased via the Internet and downloaded from a local outlet, for example, by near field RF communication, once the local outlet has verified payment, for example, using a payments applications platform of the secure element. The transport applications platform installed on the secure element will then load the received train ticket data onto the already established transport platform. Loading of the ticket data will result in the loading of a memory map onto the SIM card which is specific to the relevant electronic ticket being purchased. Loading will only occur once the mobile telephone has been authenticated and payment has been processed for the ticket.

The way in which the secure element is loaded with data will depend on the type of secure element, the way in which the secure element is provided and the purpose for which it is provided. For example, the procedure described above with respect to FIGS. 8 and 9 may be used where the secure element is a SIM card within a mobile telephone whereas where the secure element is a secure card such as an SD card, then that card may be provided programmed as described above or pre-programmed with a specific application platform or platforms and only specific application data loaded during use. Likewise the mechanism by which data is loaded on to the secure element will vary depending on the secure element.

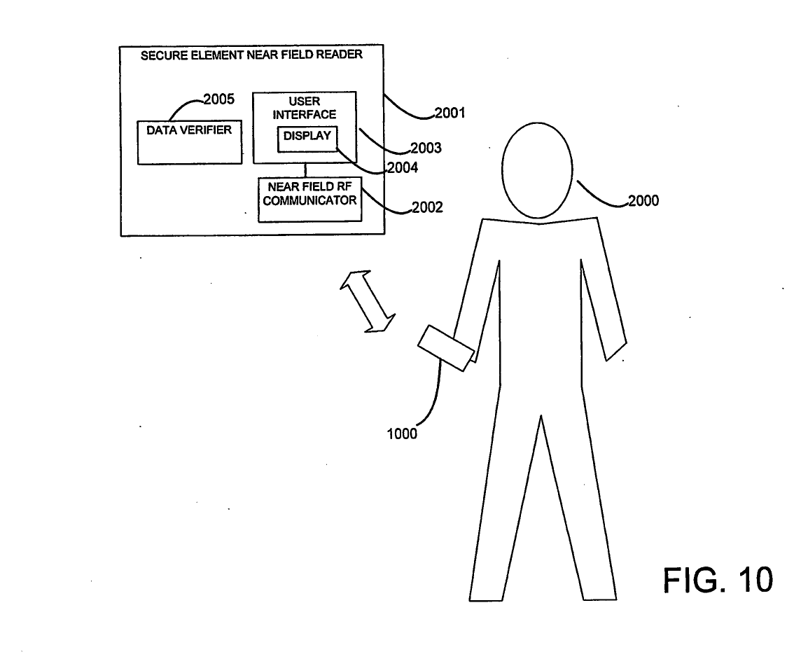

The manner in which a device embodying the invention having a secure element upon which is installed a transport applications platform and ticket data is used to gain entry with that ticket will now be described with the aid of FIG. 10 which shows a very schematic representation of a user 2000 having a device 1000 embodying the invention (for example, any of the devices described above, which are capable of responding to initiation of near field communication by an RF transceiver) in front of a secure element near field reader 2001 incorporating a near field RF communicator 2002 (for example, an RF transceiver). Although not shown in FIG. 10, the reader 2001 may automatically control an access gate to give the user of the device access to a ticket controlled area only in the event received ticket data is validated. For example, the access gate may allow access to a platform or waiting area. As another possibility, the reader may not be an automatic access controller but may be a portable device carried by an attendant, ticket inspector or usher who allows access only when the ticket data is verified. The near field reader 2001 also has a data verifier which may include decryption software or hardware to enable decryption of received authentication codes from the device 1000.

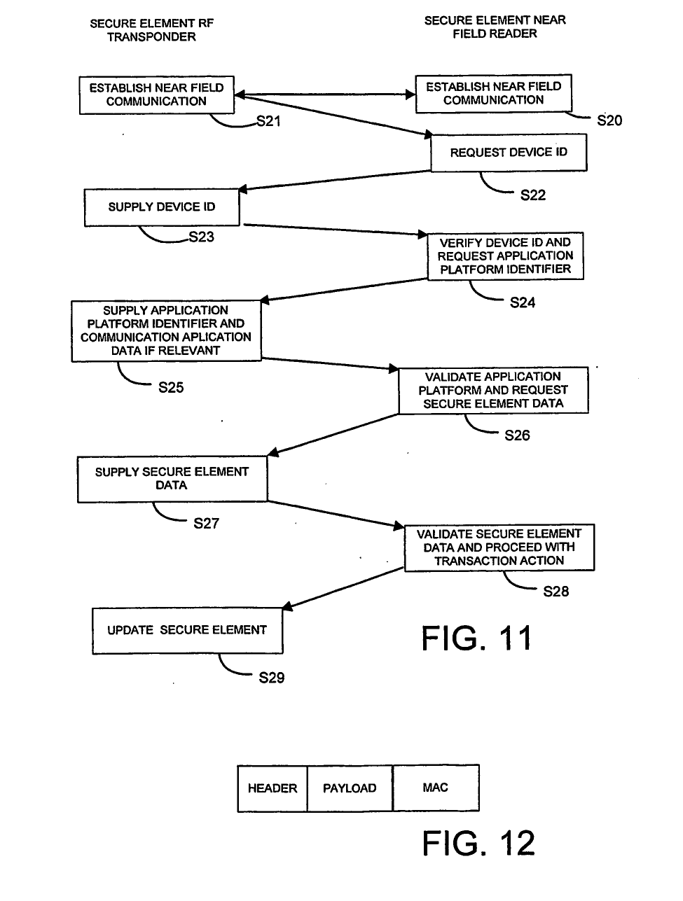

FIG. 11 shows a flow chart illustrating operations carried out by the user's device 1000 and the reader 2001. These operations will be explained for the case where the device is a smart card embodying the invention having a secure element and near field RF communicator in the form of an RF transponder, the secure element carrying train ticket data. The reader 2001 is at a transport gate. It will however be appreciated that similar operations will occur for any device embodying the invention and any transaction data.

The user 200 takes the smart card device 1000 with its secure element programmed with the ticket data to the relevant train station and presents the device 1000 to the reader 2001 on the transport gate.

An example of the ticket data carried by the secure element is shown in FIG. 12. The ticket data or ticket identifier consists of a header specific to the secure element, a payload which will contain the device ID and applications platform ID and a message authentication code (or “MAC”). The MAC is created by an internally stored algorithm of the secure element and is intended to be checked by the reader at each communication so as to ensure the authenticity of the device and the communication. The ticket header will store data specific to the relevant ticket, for example, 1 day ticket from Reading station to London Station.

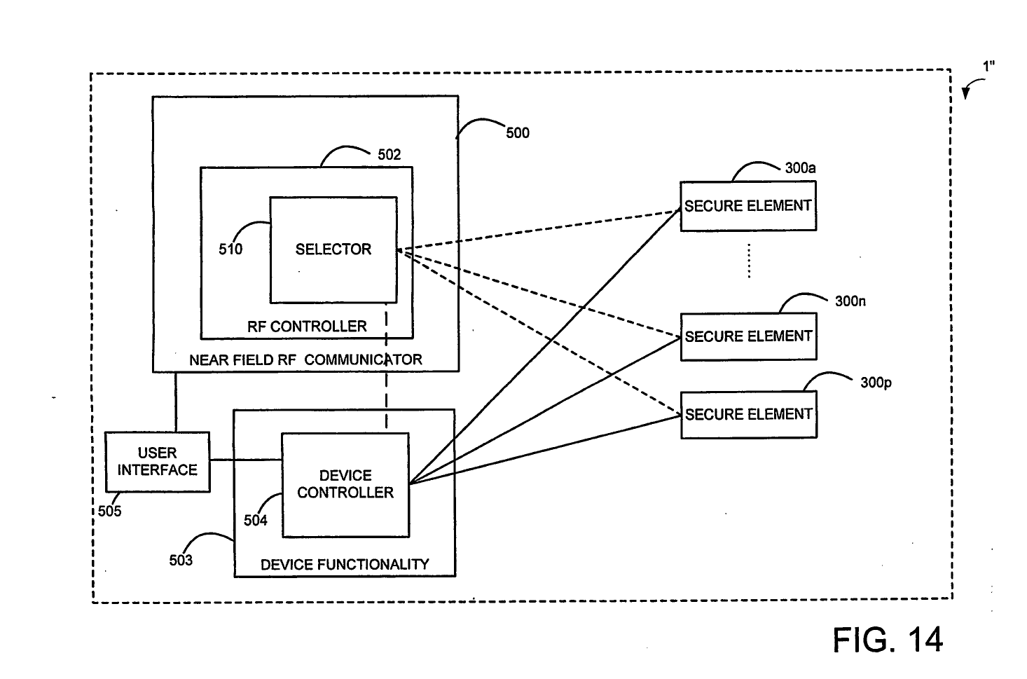

The reader 2001 polls or looks for compatible near field RF communicators by transmitting a wake-up RF signal. When the device 1000 is in read range of the reader 2001, the wake-up RF signal initiates the RF transponder (S20 in FIG. 14) within the device 1000. The wake-up signal may also provide operating power to the RF transponder. The RF transponder responds at S21 with a suitable wake-up response, for example, as provided in ISO/IEC 14443A.

On receipt of the wake-up response, the reader 2001 modulates its transmitted RF field with data representing a device ID request command to request identification of the RF transponder at S22. The RF transponder responds by modulating the transmitted RF field with data representing the MAC and an identifier or device ID specific to the device 1000 and device operating system at S23. On receipt of the device ID the reader (using its data verifier 2005) decrypts, verifies and authenticates the provided MAC and device ID and, provided the device ID is accepted (for example, is in compliance with the reader operating protocols), then the reader requests supply of an applications platform identifier for each platform accessible to the RF transponder at S24.

On receipt of the request, the RF transponder responds with the MAC and applications platform identifier(s) for the platform(s) it has access to. These applications platforms may be stored within the RF transponder's own data store but are preferably stored on the secure element of the device. As an example, where the secure element has a transport applications platform loaded on to it, the identification data specific to that transport platform will be supplied to the RF transponder by the secure element controller and the RF transponder then causes the transmitted RF field to be modulated in accordance with that supplied applications platform identifier at S25.

On receipt of the applications platform identifier, at S26 the data verifier or reader decrypts, verifies and identifies the MAC and applications platform and, provided the applications platform identifier is accepted, modulates the RF field with a request for transaction data, in this example a request for ticket detail data.

Where the device user has bought a ticket, the data for the ticket will have been loaded on to the transport applications platform on the secure element. Accordingly at S27, following receipt of a request from the reader, the RF transponder supplies the request to the secure element, retrieves the ticket data and then responds to the reader by modulating the RF field with the MAC and ticket data.

At S28, the data verifier or reader decrypts, processes and verifies the received data and, where the ticket data is accepted, permits access through the ticket gate. In this example, the reader validates the ticket and allows access either by automatically opening the transport gate or barrier or by informing an operator or ticket inspector that the ticket is valid. The reader may, at the same time, supply data or commands to the RF transponder to indicate ticket status or to deduct a sum of money from a ticket account. For example, where the reader is allowing entrance (such as entrance to an underground station or train platform), then the reader may communicate, via the RF transponder, data to be stored by the secure element in a writable area of its memory to indicate that the ticket is in use whereas where the reader is allowing exit then the reader may communicate, via the RF transponder, command data to cause the secure element to cancel the ticket, to reduce the number of available journeys by one or to deduct a sum of money from a total stored by the ticket data, or to log the transaction in some way, for example, to provide a time stamp related to, for example, the date of issue, expiry date (where the current time and/or date may be derived from the mobile telecommunications network, for example, when the ticket is purchased), as appropriate. The RF transponder will cause this data to be written to the secure element, so altering the data held by the secure element at S29 in FIG. 11.

As part of the communications process, the reader may also supply ID information or for example, a media identification code. This may be used, depending upon the device architecture, by the RF transponder or secure element controller (or larger host system processor as relevant) to determine, for example, the authenticity of the reader and/or its authority, for example, to request the device to carry out a certain action or command, to change data stored by the secure element, to receive data from the secure element and so on. For example, the RF transponder may refuse to communicate any data unless the external device is verified, and at S29 in FIG. 11, the secure element may refuse to accept any instruction to delete contents of the secure element where that instruction is received from an external device or where that instruction is received from an un-verified external device.

The device may, for example, where the device is a mobile telephone or PDA or laptop, be configured to provide, via the user interface, a user with the capability to view data and/or applications stored on the secure element. For example, the mobile telephone PDA or laptop processor or near field RF controller, depending upon the device architecture, may be configured to control access to the secure element and through its interface with the secure element enable the user to select secure element or contents within the secure element from a menu service provided by the device user interface on the mobile telephone or PDA or laptop for display in a user friendly format by a display of the device user interface. The same data may be available to a user as a display on a smart card where secure element and near field RF communicator are not comprised within a larger device or host system.

As another possibility, the contents or certain of the contents of the secure element may automatically be displayed to the user, or a menu indicator may appear to indicate the secure element contents once the secure element has been inserted into the device or activated. The user may be given the option of turning off the display or menu indicator.

As a further example, the user control may extend to the ability to delete the contents or certain of the contents (for example, only data defined as user accessible) of the secure element by the user. The user may also be given limited modification rights to modify the contents of the secure element (for example, to change personal access codes). However, the user will of course generally not be given rights to change transaction data, for example, once a user has bought a particular train ticket, the user should not be able to modify that train ticket or change the data stored on the secure element in relation to that train ticket.

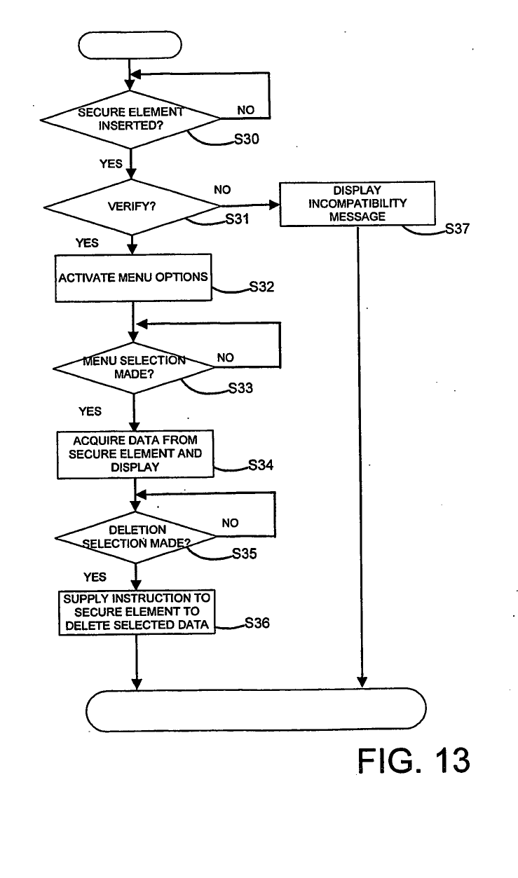

FIG. 13 shows an example flowchart illustrating user intervention with a secure element. In the example of FIG. 16, the secure element is a removable secure element such as an SD card and the device is a mobile telephone. In this illustrative example, the removable secure element holds several different tickets which the user has purchased, these tickets being for, for example, different venues and events.

When at S30 in FIG. 13 the user inserts the removable secure element into the mobile telephone, the removable secure element interfaces with the mobile telephone controller. This interface may, as discussed above, be an ohmic contact via electrical contacts which mate with corresponding contacts within the mobile telephone or a wired or wireless link.

Following insertion of the removable secure element at S30, the mobile telephone controller requests identification and authentication data from the removable secure element and verifies the authenticity of the removable secure element and the compatibility of the removable secure element with its own internal protocols and set-up at S31. If authentication or compatibility is not achieved, the mobile telephone controller will cease communicating with the removable secure element and will at S37 display a message to the user indicating that the removable secure element is not compatible.

Once the removable secure element is authenticated, at S32 the mobile telephone controller activates menu options (which were not previously displayed or were inactive or “greyed out”) so that the user can view these menu options on the display in similar fashion to other mobile telephone menu options.

The mobile telephone controller then waits at S33 for a user menu selection from the available menu options. As an example, if the user wishes to view the contents of the removable secure element, for example, if the user wishes to see the number of transactions such as tickets held on the removable secure element, the user may select an option to view the transaction contents data of the removable secure element. Following selection, the mobile telephone controller requests the appropriate data from the removable secure element and converts it into a form which can be displayed on the mobile telephone display at S34. The data displayed will depend on the contents of the removable secure element, for example, the display may simply list the number of transactions, for example, tickets, available, it may provide details on the transactions (for example, ticket venue, date etc).

Should the user wish to delete data, for example, where a ticket has expired, the user may then select the particular item on the display screen and request deletion using the menu options. When at S35 the mobile telephone controller receives a user instruction to delete transaction data, then the mobile telephone controller at S36 supplies a delete instruction to the removable secure element at S36 and the removable secure element checks the authority to delete and if the user has this for this data either actually deletes the corresponding data in its entirety or deletes its identifier and unlocks the relevant section of memory so that it is free to be overwritten. The data will then no longer be available on the removable secure element.

In the description with reference to FIG. 13, it is the mobile telephone controller which communicates with the user via the user interface. Depending upon the device architecture, it could be the near field RF controller.

In the above described examples, a device has a single secure element. FIG. 14 shows a functional block diagram of a device 1″ embodying the invention that is capable of receiving a number of secure elements (three 300a, 300n, 300p are shown as an example) each of which may have a different operating system and different applications platforms which, as described above, may be pre-stored or supplied via a communications facility of the device or the near field RF communicator of the device. Each of the secure elements may communicate in accordance with different secure interface protocols, examples of which are S2P and SWC. The device 1″ has, like the devices described above, a near field RF communicator 500 with an RF controller 502 and may have device functionality (for example, mobile telephone functionality) 503 with a device controller 504, and a user interface 505. These features of the device 1″ may have any of the configurations described above. The device 1″ differs from those described above, in that the RF controller is configured to provide a selector 510 that is capable of selecting the appropriate secure element for communication with an external near field RF communicator or NFC communicator on the basis of, for example, user selection of a secure element via a user interface (generally a menu on a display) of the device. Thus, for example, where the device has different secure elements for different transactions, when the near field RF communicator is activated by a polling reader, the controller of the device may cause its display to display to the user a menu listing the available secure elements so that the user can select the appropriate one on the basis of information displayed at or in association with the reader with which the near field RF communicator is communicating. Upon receipt of the user selection, the RF controller (possibly upon instructions from the device controller, depending upon the architecture) causes the selector or switch 510 to couple the appropriate secure element to the device controller 504 (as shown in solid lines in FIG. 14) where the controller 504 communicates with the secure elements or to the RF controller 502 (as shown in dashed lines in FIG. 17), where the RF controller 502 communicates with the secure elements and the RF controller communicates with the device controller 504.

As another possibility or additionally, where a secure element has a large number of applications platforms, the user may be given a menu option to select a platform.

In the alternative, the user may control both the selection of the secure element and use of near field RF communicator. For example, where the user approaches an access gate, for example, to a train station platform, the user may select near field RF communication on the communicating device (for example, a mobile phone). Selection may be made via a user interface (generally a menu on a display) of the device. This will activate the near field RF communicator within the device. As a result of such selection, the user interface will then show the transaction data available, for example, one day return train ticket from Reading to London, bus ticket from London to Gatwick. The user then selects the transaction data required, thus selecting the relevant secure element and application platform. Once selected, the RF controller or device controller causes a selector or switch (510 in FIG. 17) to couple the appropriate secure element.

As described above, generally data will be secured by, for example, public/private key encryption or security algorithm, where the communication is external to the device and where the communication is with a secure element. A secure element may use any appropriate encryption algorithm to secure data, provided of course that this can be decrypted by the eventual legitimate reader.

The near field RF communicator (for example, the near field RF communicator in FIG. 7 or in FIG. 4) may be implemented as an integrated circuit connected to any peripherals and an antenna. Within the integrated circuit, there will be analogue and digital domains—the proportion of each of these domains will depend on the integrated circuit. Likewise, some of the functionality may be carried out in software within the controller of the near field RF communicator or as another possibility, depending on architecture, the secure element or host system processor. As another possibility, the near field RF communicator may be incorporated or comprised within other suitable formats, for example, on a PCB board. Where appropriate, the integrated circuit or other format may be a stand-alone device, for example, the device may be incorporated into a label, electronic token, transport ticket or access card.

As described above, where a device embodying the invention has device functionality having a controller or processor in addition to the near field RF communicator and secure element (for example, mobile telephone functionality), the secure element may communicate directly with the near field RF communicator or with a controller or processor of that device functionality or any combination of these, depending upon the circumstances. For example, in one arrangement described above, where a request for data is received by the near field RF communicator, the request will be provided to the controller (“host processor”) of the device functionality which will determine the response to be made and the data to be transferred and, where the relevant data is held on the secure element, the host processor will control the transfer of data from the secure element to the near field RF communicator which will then transmit the transferred data to the external near field RF communicator. In another arrangement described above, where the near field RF communicator has a direct link to the secure element, then relevant data may be transferred directly from the secure element to the near field RF communicator and from there be transmitted to the external near field RF communicator or NFC communicator. In another arrangement described above, there may be no direct link between any host processor and the secure element and in such circumstances the NFC communicator controller and/or the processor of the secure element will control transmission of data from the secure element.

The near field RF communicator controller may interface with the “host processor”,for example, a mobile telephone processor, and be controlled by such processor.

During any communication between the near field RF communicator and an external near field RF communicator or NFC communicator various identifications and authentications will occur such as the MAC identification discussed above. The external near field RF communicator may (or may not depending upon the security level required) request authentication/verification of the near field RF communicator prior to any transmission of data from the secure element and vice versa. Authentication and verification of any component by another may be required, for example, an external near field RF communicator may require authentication and verification of the device, the operating system, applications platform and transaction data prior to any communication of data and any of these may require authentication and verification of an external near field RF communicator prior to any communication of data.

An embodiment provides a mobile telephone or PDA or laptop comprising a secure element and near field RF communicator. As another possibility, a mobile telephone or PDA or laptop may be operable to interface with a secure element and near field RF communicator. One or both of the secure element and/or near field RF communicator may be removable from the mobile telephone or PDA or laptop. The secure element may be any secure element described above. The near field RF communicator may be any near field RF communicator. The near field RF communicator or parts of the near field RF communicator may or not be integral with components of the mobile telephone or PDA or laptop.

In examples described above, a near field RF communicator is incorporated within a larger device. In such a case, the near field RF communicator may be a discrete entity within the host device or may be provided by features dispersed throughout or integrated within the host device or a part of the host device. Where near field RF communicator is within a larger device or system, all of the functionality may be comprised within the central processing board of the larger device or system or as another possibility split between different processing boards. In addition, the functionality of a near field RF communicator may be provided by software and/or firmware and/or hardware, as appropriate.

It will be appreciated that the above gives mobile telephones and PDAs and laptops as examples of host devices. A host device may be another type of electrical device such as another portable electrical device such as a portable audio and/or video player such as an MP3 player, an IPOD®, CD player, DVD player or other electrical device.

As used herein, “secure element” means any element which is capable of being used to hold secure encrypted or protected information and/or data. Not all of the data held by the secure element need be encrypted or protected. The secure element may be a discrete device that may be removable from the device to enable the addition of extra applications or functionality. As another possibility, the secure element may be integrated with hardware and/or software of the device, for example, be integrated with hardware and/or software of, for example, a mobile phone, PDA, lap-top computer or other electrical device.

An embodiment provides an electronic proof carried by a device as described above, where the proof is provided by the transaction data which represents or is associated with a combination of operating system, applications layer and specific application data, such specific application data comprising at least one of: a transport ticket or pass which may be a single, return, multiple journey or season ticket for example; an entertainment ticket such as a cinema, theatre or sports ticket; a receipt such as for purchase of goods or services; an access pass or key; a permit or coupon; a reservation or booking such as a hotel reservation, a hire car reservation, or a restaurant reservation; a product such as goods or services; a financial product such as a credit card, pin number, debit card, money, loyalty card.

A near field RF communicator may be combined with a removable secure element, for example, an NFC-enabled SD card or flash memory card, so that the combination is insertable and/or removable from a host device. The secure element may then provide a data store for the near field RF communicator. The secure element may share processor power with the near field RF communicator or as another possibility the near field RF communicator may be controlled by the secure element processor. As described above, the combined near field RF communicator secure element may be used as a stand-alone device or as another possibility may be inserted into another electrical device or host device, for example, a mobile telephone or PDA.

In an embodiment, the controller of the secure element may control at least some of the functionality of the near field RF communicator or possibly even a host device, for example, the secure element may control aspects of the host device that relate to display of its data.

As described above, the data communicated is transaction data providing or associated with details of a transaction. A transaction may or may not be a financial transaction. A transaction may be a purchase of a product such as goods or services, a ticket or access pass such as a transport ticket, for example, an airplane, train, underground, bus, tram, boat, etc. ticket, a ticket for an attraction such as a sporting or other entertainment event, a cinema or theatre ticket, a reservation or booking such as a hotel reservation, a hire car reservation, or a restaurant reservation, and so on. In an embodiment, transaction data stored by the secure element comprises transport data, more particularly data representing a transport ticket, a journey or payment for a journey. In an embodiment, transaction data stored by the secure element comprises access data, more particularly data entitling the user of the near field RF communicator to have access to a building, location or area.

The secure element operating system, applications platforms and transactions data may be supplied by the same or different service providers. Applications platforms may be hierarchical so that, for example, there may be a general transport applications platform and specific platforms for different types of transport or for different countries or transport networks.

Where the near field RF communicator is an RF transponder that derives power from a received signal, then it may be configured to communicate its data once powered-up. In such a case, it may not be necessary for the RF transponder to be able to receive instructions and accordingly the RF transponder may not include a demodulator.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention.

1. A communications device, the device comprising:
(a) a near field RF communicator having a coupler operable to couple with a coupler of at least one of a near field RF communicator or NFC communicator in near field range to enable communication of data between the communicators by modulation of a magnetic field, and a modulator to modulate an RF signal in accordance with data to be communicated by the near field RF communicator;
(b) at least one secure element to provide data storage for transaction data representing or relating to a transaction; and
(c) a controller to control operation of the near field RF communicator, to read transaction data from the at least one secure element, and to cause the modulator to modulate an RF signal in accordance with transaction data read from the at least one secure element so as to communicate the read transaction data to a near field RF communicator or NFC communicator in near field range as proof of the transaction to enable an action related to the transaction to be carried out.

2. A device according to claim 1, wherein the at least one secure element is at least one of:
(a) separate from the near field RF communicator;
(b) insertable into the device;
(c) removable from the device;
(d) connectable to the device; and
(e) couplable to the device.

3. A device according to claim 1, wherein at least one of:
(a) the controller comprises a controller of the near field RF communicator;
(b) the near field RF communicator is an RF transceiver or an RF transponder; and the device further comprises a communicator to communicate other than by near field RF communication; and
(c) the at least one secure element has a plurality of memory areas and at least one of:
(i) the at least one secure element is operable to write data to a selected memory area or areas in dependence upon the route of supply or identity of supplier; and
(ii) at least one of such memory areas is readable by a user but not amendable by the user and at least one of such memory areas not being readable by a user.

4. (canceled)

5. (cancelled)

6. (cancelled)

7. (cancelled)

8. (cancelled)

9. (cancelled)

10. A device according to claim 1, wherein the near field RF communicator is separate from the at least one secure element and the device further comprises a mobile telecommunications communicator operable to communicate via a mobile telecommunications network, wherein the controller comprises a mobile telecommunications controller operable to control the mobile telecommunications communicator and to cooperate with the near field RF communicator, the mobile telecommunications controller being operable to read transaction data from the at least one secure element and to cause the near field RF communicator to modulate an RF signal in accordance with transaction data read from the at least one secure element.

11. A device according to claim 1, wherein the at least one secure element is at least one of:
(a) configured to have an operating system and at least one applications platform;
(b) at least partly pre-programmed;
(c) at least partly programmable by the controller; and
(d) configured to be loaded with at least one specific application.

12. (canceled)

13. (canceled)

14. (canceled)

15. A device according to claim 1, wherein the controller is arranged to at least one of:
(a) cause specific application data to be stored by the at least one secure element;
(b) obtain by communication with another device at least one of:
(i) operating software,
(ii) at least one applications platform for a particular type of specific application data, and
(iii) specific application data for storage by the at least one secure element; and
(c) communicate with another device by at least one of a mobile telecommunications network and near field communication to obtain at least one of:
(i) operating software,
(ii) at least one applications platform for a particular type of transaction data, and
(iii) transaction data for the at least one secure element.

16. (canceled)

17. (canceled)

18. A device according to claim 15, configured to download operating software or an applications platform as an applet.

19. A device according to claim 1, wherein the device has a selector that is configured to at least one of:
(a) select a secure element from amongst a plurality of secure elements;
(b) select an applications platform from amongst a plurality of applications platforms; and
(c) be user-controllable.

20. (canceled)

21. A device according to claim 1, wherein at least one of:
(a) said at least one secure element comprises a SIM card, a USIM card, a WIM card, a SWIM card, an SD card, a SMC card or other form of secure element;
(b) the transaction data comprises at least one of: payment data; product data; purchase data; ticket data; permit data; pass data; booking data; reservation data; and
(c) the device comprises a label, smart card, token or electronic card.

22. (canceled)

23. (canceled)

24. A communications device comprising:
(a) a near field RF communicator having a coupler operable to couple with a coupler of a near field RF communicator or NFC communicator in near field range to enable communication of data between the communicators by modulation of a magnetic field, and a modulator to modulate an RF signal in accordance with data to be communicated by the near field RF communicator;
(b) at least one secure element separate from the near field RF communicator to provide secure data storage; and
(c) a controller to control operation of the near field RF communicator, to read data from the at least one secure element and to cause the modulator to modulate an RF signal in accordance with data read from the at least one secure element so as to communicate the read data to a near field RF communicator or NFC communicator in near field range.

25. A device according to claim 1, wherein at least one of:
(a) the device consists of only the near field RF communicator and the at least one secure element;
(b) the device additionally has a display, wherein the controller is operable to enable a user to view at least some of the data stored on the at least one secure element; and
(c) the controller is operable to enable deletion of data from the secure element by the user.

26. (canceled)

27. (canceled)

28. A communications device, the device comprising:
(a) near field RF communication means having coupling means for coupling with coupling means of a near field RF communication means or NFC communication means in near field range to enable communication of data between the communication means by modulation of a magnetic field, and modulation means for modulating an RF signal in accordance with data to be communicated by the near field RF communicator;
(b) secure element means for providing secure data storage for transaction data representing or relating to a transaction; and
(c) control means for controlling operation of the near field RF communication means, for reading transaction data from the secure element means and for causing the modulation means to modulate an RF signal in accordance with transaction data read from the secure element means so as to communicate the read transaction data to a near field RF communication means or NFC communication means in near field range as proof of the transaction to enable an action related to the transaction to be carried out.

29. An electronic proof device comprising control means and memory means storing an operating system, at least one application platform configured to run on the operating system, the at least one application platform having at least one application layer for electronic proof data.

30. A device according to claim 29, comprising communications means to enable at least one of the operating system, a said application platform and a said application layer to be downloaded to the device.

31. (canceled)

32. A device according to claim 30, wherein the communications means comprises at least one of:
(a) wired or wireless communications means;
(b) near field RF communications means to enable download from at least one of a near field RF communications-enabled device and a NFC communications-enabled device in near field communications range;
(c) internet communications means to communicate via the internet, and
(d) mobile telephone communications means to communicate via a mobile telephone communications network.

33. (canceled)

34. A device according to claim 29, wherein the device is configured to at least one of:
(a) allow stored data to be changed by communication with a verified communicator; and
(b) allow a verified communicator to at least one of cancel, modify, log and time stamp stored electronic proof data.

35. (canceled)

36. A device according to claim 29, wherein at least one of:
(a) the operating system comprises a Java or Java-compatible operating system, a Java applet or Java MIDlet;
(b) a said application platform comprises a JAVA applet;
(c) a said application layer comprises an application platform ID, a message authentication code, and electronic proof specific data;
(d) the electronic proof specific data includes at least one of date, time, duration and location data;
(e) the application layer comprises electronic proof data providing at least one of ticket, pass, permit and financial data;
(f) the electronic proof data comprises ticket data representing at least one of a transport ticket, an events ticket, a cinema ticket, a theatre ticket and a sports ticket;
(g) a said application platform is a transport application platform which may comply with ISO/IEC 14443 and the at least one application layer comprises electronic proof data representing at least one transport ticket;
(h) the at least one application layer comprises electronic proof data representing at least one transport ticket selected from the group consisting of a single journey ticket, a return journey ticket, a multiple journey ticket and a season ticket;
(i) the electronic proof data comprises financial data representing at least one of a credit card, a debit card, a loyalty card, money, and a PIN number;
(j) at least part of the memory means comprises write once only memory;
(k) at least part of the memory means comprises re-writeable memory;
(l) at least one of the operating system, a said application platform and a said application layer is stored in write once only memory or non-reprogrammable memory and cannot be rewritten;
(m) at least one of the operating system, a said application platform and a said application layer is stored in re-writeable memory to enable said operating system, a said application platform or a said application layer to be replaced or rewritten;
(n) at least one of a said application platform, a said application layer and electronic proof data of a said application layer comprises encrypted data;
(o) a said application layer comprises a memory map;
(p) the device is configured to store plural electronic proofs;
(q) a said application layer comprises a respective memory map for each of a plurality of electronic proofs;
(r) the device is pre-loaded with at least one of the operating system, application platform or electronic proof data;
(s) the device is configured to allow input of electronic proof data by at least one of a user input device and near field RF communication with an RF transponder or tag;
(t) the device is a secure element, a SIM card, SD card or smart card.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. An electronic ticket device for use in a near field RF communications system, the electronic ticket device comprising a secure element having a controller, a memory for enabling secure data storage, and a coupler for coupling with at least one of a near field RF communicator and a NFC communicator to enable communication of ticket data between the secure element and the at least one of a near field RF communicator and a NFC communicator, the device being programmed with an operating system, an application platform defining transaction protocols relating to the electronic ticket device, and an application layer for storing ticket data for at least one ticket.

61. A method of supplying transaction data or product data to the at least one secure element of a device according to any of the preceding claims, which comprises supplying at least one of secure software and secure data to the device for storage on the secure element.

62. A method according to claim 19, wherein the supplying comprises at least one of:
(a) supplying at least one of a Java applet, a midlet, other software program, transaction data; and
(b) supplying by at least one of mobile telecommunication and near field RF communication.

63. (canceled)
